(19) United States
(12) Patent Application Publication
(10) Pub. No.: US 2016/0028107 A1
(43) Pub. Date: Jan. 28, 2016

(54) METHOD OF MANUFACTURING POSITIVE ELECTRODE FOR SOLID-STATE BATTERY, METHOD OF MANUFACTURING SOLID-STATE BATTERY, AND POSITIVE ELECTRODE SLURRY

(71) Applicant: TOYOTA JIDOSHA KABUSHIKI KAISHA, Toyota-shi (JP)

(72) Inventors: Hiroki KUBO, Susono-shi (JP); Yuichi HASHIMOTO, Numazu-shi (JP); Yuki MATSUSHITA, Atsugi-shi (JP); Keisuke WATANABE, Tokyo (JP); Yoshiyuki NAGASAWA, Tokyo (JP)

(21) Appl. No.: 14/805,902

(22) Filed: Jul. 22, 2015

(30) Foreign Application Priority Data
Jul. 23, 2014 (JP) 2014-149708

(51) Int. Cl. H01M 10/0562; H01M 4/04; H01M 4/62

(52) U.S. Cl. CPC H01M 10/0562; H01M 4/623; H01M 4/0402; H01M 2004/028

(57) ABSTRACT

Provided is a method of manufacturing a positive electrode for a solid-state battery, the method including: a step of mixing a positive electrode active material, a sulfide solid electrolyte, a binder, and a solvent with each other to prepare a positive electrode slurry; a step of applying the prepared positive electrode slurry to a surface of a solid electrolyte layer of the solid-state battery or a substrate of the positive electrode; and a step of drying the applied positive electrode slurry. In this method, the solvent is butyl butyrate, and the binder is a copolymer containing a vinylidene fluoride (VDF) monomer unit and a hexafluoropropylene (HFP) monomer unit, in which a molar ratio of the HFP monomer unit to a total amount of the VDF monomer unit and the HFP monomer unit is 10% to 20%.

### INCORPORATION BY REFERENCE

The disclosure of Japanese Patent Application No. 2014-149708 filed on Jul. 23, 2014 including the specification, drawings and abstract is incorporated herein by reference in its entirety.

### BACKGROUND OF THE INVENTION

1. Field of the Invention

The present invention relates to a method of manufacturing a positive electrode for a solid-state battery

2. Description of Related Art

As a battery having high safety, a solid-state battery is known. The solid-state battery includes: electrodes that include an active material; and a solid electrolyte layer that is a separator layer interposed between the electrodes. The electrodes or the solid electrolyte layer can be easily manufactured using a slurry in which an active material or a solid electrolyte is dispersed in a solvent. For example, as described in Japanese Patent Application Publication No. 2013-118143 (JP 2013-118143 A), a desired electrode layer can be obtained through the following steps of: mixing an electrode active material, a sulfide solid electrolyte, a binder, and a solvent to prepare a slurry; applying the slurry; and drying the slurry. In this case, as the binder, for example, a fluorine-based binder such as polyvinylidene fluoride or a copolymer of vinylidene fluoride (VDF) and hexafluoropropylene (HFP) disclosed in Japanese Patent Application Publication No. 2013-222530 (JP 2013-222530 A) and Japanese Patent Application Publication No. 2012-138346 (JP 2012-138346 A) is known.

When a slurry is applied to form an electrode layer as in the case of the related art, it is preferable that the slurry is dried by fast drying using heating after the application from the viewpoint of improving productivity. However, when a combination of a binder and a solvent of the related art is dried by fast drying, battery performance may deteriorate. That is, the binder may be unevenly distributed in an electrode by fast drying. As a result, the resistance may increase, and the output of a battery may decrease.

In addition, a solvent which is used in the related art may react with a sulfide solid electrolyte to decrease the lithium ion conductivity in the sulfide solid electrolyte.

In addition, when a three-component copolymer of VDF, HFP, and tetrafluoroethylene (TFE) or polyvinylidene fluoride is used as a binder, the adhesive force between a current collector and an electrode layer is not sufficient, and the peeling or cracking of an electrode may occur during the manufacture of a solid-state battery.

As described above, in the related art, when a positive electrode for a solid-state battery is manufactured, the following effects of suppressing deterioration of a sulfide solid electrolyte, securing a sufficient adhesive force between a current collector and an electrode layer, and suppressing a decrease in battery output caused by fast drying, cannot be simultaneously obtained.

### SUMMARY OF THE INVENTION

The invention provides a method of manufacturing a positive electrode for a solid-state battery, a method of manufacturing a solid-state battery, and a positive electrode slurry, capable of suppressing deterioration of a sulfide solid electrolyte, securing a sufficient adhesive force between a current collector and a positive electrode layer, and suppressing a decrease in battery output caused by fast drying.

The present inventors thoroughly studied a method of manufacturing a positive electrode for a solid-state battery using a positive electrode slurry. As a result, the following multiple findings were obtained.

(1) In a positive electrode slurry, when a three-component copolymer of vinylidene fluoride (VDF), hexafluoropropylene (HFP), and tetrafluoroethylene (TFE) or polyvinylidene fluoride is used as a binder, the resistance increases due to the fast drying of the slurry, and the battery output decreases. The reason is presumed to be that the binder is segregated on the surface of the positive electrode during drying.
(2) In order to suppress deterioration of a sulfide solid electrolyte, it is effective to use a solvent having low reactivity with a sulfide solid electrolyte as a solvent constituting a slurry. As a result of thorough research, it was found that the use of butyl butyrate, dibutyl ether, or cyclopentyl methyl ether is effective as the solvent.
(3) In a case where the three-component copolymer or polyvinylidene fluoride is used as a binder in a positive electrode slurry, when any one of the solvents of (2) described above is used, the adhesive force between a positive electrode layer and a current collector is not sufficient particularly in a positive electrode which is obtained through fast drying.
(4) In a positive electrode slurry, when a two-component binder of VDF and HFP is used as a binder, the binder cannot be made to be dissolved or dispersed well in dibutyl ether and cyclopentyl methyl ether among the solvents of (2) described above, and the adhesion between a positive electrode layer and a current collector cannot be secured. On the other hand, at a specific copolymerization ratio in the binder, the binder can be highly dispersed in butyl butyrate among the solvents of (2) described above, and a sufficient adhesive force can be secured between a positive electrode layer and a current collector in a positive electrode obtained from the slurry. In addition, a decrease in battery capacity caused by fast drying can be suppressed. Specifically, a copolymerization ratio (molar ratio) of HFP in the binder is set to be 10% or higher.
(5) On the other hand, when a copolymerization ratio (molar ratio) of HFP in a two-component binder of VDF and HFP is higher than 20%, flexibility increases along with an increase in the copolymerization ratio of HFP, and the binder becomes flexible. That is, in order to cause a binder to appropriately function, a copolymerization ratio (molar ratio) of HFP in the binder is 20% or lower.
(6) As described above, during the manufacture of a positive electrode for a solid-state battery, when a two-component binder of VDF and HFP having a predetermined copolymerization ratio is used as a binder, and when butyl butyrate is used as a solvent, deterioration of a sulfide solid electrolyte can be suppressed, a sufficient adhesive force can be secured between a current collector and a positive electrode layer, and a decrease in battery output caused by fast drying can be suppressed.

The invention has been made based on the above-described findings. That is, according to a first aspect of the invention, there is provided a method of manufacturing a positive electrode for a solid-state battery, the method including: a step of mixing a positive electrode active material, a sulfide solid electrolyte, a binder, and a solvent with each other to prepare a positive electrode slurry; a step of applying the prepared positive electrode slurry to a surface of a solid electrolyte layer of the solid-state battery or a substrate of the positive electrode; and a step of drying the applied positive electrode slurry. In this method, the solvent is butyl butyrate, and the binder is a copolymer consisting of a vinylidene fluoride (VDF) monomer unit and a hexafluoropropylene (HFP) monomer unit, in which a molar ratio of the HFP monomer unit to a total amount of the VDF monomer unit and the HFP monomer unit is 10% to 20%.

In the invention, the meaning of “mixing a positive electrode active material, a sulfide solid electrolyte, a binder, and a solvent with each other to prepare a positive electrode slurry” includes a case where a positive electrode active material, a sulfide solid electrolyte, a binder, a solvent, and optional components other than the positive electrode active material, the sulfide solid electrolyte, the binder, and the solvent are mixed with each other to prepare a positive electrode slurry. Examples of the optional components include a conductive additive.

According to a second aspect of the invention, there is provided a method of manufacturing a solid-state battery, the method including laminating a positive electrode for a solid-state battery which is obtained using the method according to the first aspect, a solid electrolyte layer containing a solid electrolyte, and a negative electrode containing a negative electrode active material.

According to a third aspect of the invention, there is provided a positive electrode slurry containing a positive electrode active material, a sulfide solid electrolyte, a binder, and a solvent. In the positive electrode slurry, the solvent is butyl butyrate, and the binder is a copolymer consisting of a vinylidene fluoride (VDF) monomer unit and a hexafluoropropylene (HFP) monomer unit, in which a molar ratio of the HFP monomer unit to a total amount of the VDF monomer unit and the HFP monomer unit is 10% to 20%.

A content of the binder may be 0.5 parts by mass to 3.5 parts by mass with respect to 100 parts by mass of the positive electrode active material.

In the invention, during the manufacture of a positive electrode for a solid-state battery, a two-component binder of VDF and HFP having a predetermined copolymerization ratio is used as a binder, and butyl butyrate is used as a solvent. According to the invention, deterioration of a sulfide solid electrolyte can be suppressed, a sufficient adhesive force can be secured between a current collector and a positive electrode layer, and a decrease in battery output caused by fast drying can be suppressed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram showing the procedure of preparing a binder solution in an example of the invention;

FIG. 2 is a schematic diagram showing the procedure of preparing a positive electrode slurry in an example of the invention;

FIG. 3 is a schematic diagram showing the procedure of manufacturing a solid-state battery in an example of the invention;

FIG. 4 is a schematic diagram showing a method of a vertical peel test for evaluating the adhesive force of a positive electrode; and

FIG. 5 is a diagram showing a change in the resistance value of a solid-state battery between a case where a positive electrode is manufactured through natural drying and a case where a positive electrode is manufactured through fast drying.

### DETAILED DESCRIPTION OF EMBODIMENTS

1. Method of Manufacturing Positive Electrode for Solid-State Battery

A method of manufacturing a positive electrode for a solid-state battery according to an embodiment of the invention includes: a step of mixing a positive electrode active material, a sulfide solid electrolyte, a binder, and a solvent with each other to prepare a positive electrode slurry; a step of applying the prepared positive electrode slurry to a surface of a solid electrolyte layer of the solid-state battery or a substrate of the positive electrode; and a step of drying the applied positive electrode slurry. In this method, the solvent is butyl butyrate, and the binder is a copolymer consisting of a vinylidene fluoride (VDF) monomer unit and a hexafluoropropylene (HFP) monomer unit, in which a molar ratio of the HFP monomer unit to a total amount of the VDF monomer unit and the HFP monomer unit is 10% to 20%.

1.1. Step of Preparing Positive Electrode Slurry

In the embodiment of the invention, a positive electrode active material, a sulfide solid electrolyte, a binder, and a solvent are mixed with each other to prepare a positive electrode slurry. Hereinafter, each component constituting the positive electrode slurry will be described.

1.1.1. Positive Electrode Active Material

In the embodiment of the invention, the positive electrode slurry contains a positive electrode active material. As the positive electrode active material, a positive electrode active material which is well-known as a positive electrode active material for a solid-state battery can be used. In particular, a positive electrode active material capable of storing and releasing lithium ions is preferably used. Specific examples of the positive electrode active material include LiCoO₂, Li(Ni,Co,Al)O₂, Li₁₊ₓNi_{1/3}Mn_{1/3}Co_{1/3}O₂ (x represents a real number of 0 or more), LiNiO₂, LiMn₂O₄, LiCoMnO₄, Li₂NiMn₃O₈, Li₃Fe₂(PO₄)₃, Li₃V₂(PO₄)₃, a different element-substituted Li—Mn spinel having a composition represented by Li₁₊ₓMn_{2-x-y}M_{y}O₄ (wherein M represents at least one metal selected from Al, Mg, Co, Fe, Ni, and Zn), lithium titanate (LiₓTiO_{y}), and a lithium metal phosphate having a composition represented by LiMPO₄ (M represents Fe, Mn, Co, or Ni). Among these, in the embodiment of the invention, LiCoO₂, Li(Ni,Co,Al)O₂, or LiNi_{1/3}Mn_{1/3}CO_{1/3}O₂, is preferably used as the positive electrode active material. In addition, in the embodiment of the invention, a surface of each of the above-described materials may be coated to be used as the positive electrode active material. A coating material which can be used in the embodiment of the invention is not particularly limited as long as it has lithium ion conductivity and contains a material capable of being maintained in the form of a coating layer on the surface of the active material. Examples of the coating material include LiNbO₃, Li₄Ti₅O₁₂, and Li₃PO₄. The shape of the positive electrode active material is not particularly limited but is preferably particulate.

1.1.2. Sulfide Solid Electrolyte

In the embodiment of the invention, the positive electrode slurry contains a sulfide solid electrolyte. As the sulfide solid electrolyte, a solid electrolyte containing a sulfur atom in the molecular structure or in the composition which is well-known as a solid electrolyte for a sulfide solid-state battery can be used. In particular, a glass or glass ceramic solid electrolyte containing a sulfide is preferable. For example, a solid electrolyte containing Li, A (A represents at least one of P, Si, Ge, Al, and B), and S is preferable, and a solid electrolyte further containing a halogen atom in addition to the above elements is more preferable. Specific examples of the solid electrolyte include Li₂S—P₂S₅, Li₂S—P₂S₃, Li₂S—P₂S₃—P₂S₅, Li₂S—SiS₂, LiI—Li₂S—SiS₂, LiI—Li₂S—P₂S₅, LiI—Li₂S—P₂O₅, LiI—Li₃PO₄—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge_{0.76}S₄, and Li₄₋ₓGe₁₋ₓPₓS₄. The shape of the solid electrolyte is not particularly limited but is preferably particulate.

1.1.3. Binder

In the embodiment of the invention, the positive electrode slurry contains a binder. In the embodiment of the invention, a binder which is different from that of the related art is used as the binder. Specifically, a two-component binder obtained by copolymerizing a vinylidene fluoride (VDF) monomer unit and a hexafluoropropylene (HFP) monomer unit at a predetermined copolymerization ratio is used. As a result, a sufficient adhesive force can be secured between a positive electrode layer and a current collector, and an increase in resistance during fast drying can be suppressed.

In the binder used in the embodiment of the invention, it is important to adjust a molar ratio of the HFP monomer unit to the total amount of the VDF monomer unit and the HFP monomer unit to be 10% to 20%. When the molar ratio of the HFP monomer unit is lower than 10%, the binder may not be dispersed well in a solvent (butyl butyrate) described below, and a sufficient adhesive force may not be secured between a positive electrode layer and a current collector. On the other hand, when the molar ratio of the HFP monomer unit is higher than 20%, flexibility increases along with an increase in the copolymerization ratio of HFP, and the binder becomes flexible. It can be said that the invention can exhibit the remarkable and unique effects when the copolymerization ratio of the binder is in the limited range.

It is preferable that the binder used in the embodiment of the invention does not exhibit solubility in water. In particular, the water content in the binder is preferably 100 ppm or lower in terms of mass.

The upper limit of the molecular weight of the binder used in the embodiment of the invention is preferably 1,500,000 or lower, more preferably 910,000 or lower, and still more preferably 700,000 or lower, and the lower limit thereof is preferably 270,000 or higher and more preferably 320,000 or higher. By adjusting the molecular weight of the binder to be in the above-described range, various characteristics of the binder such as the adhesive force can be further improved.

1.1.4. Solvent

In the embodiment of the invention, the positive electrode slurry contains a solvent. In the embodiment of the invention, butyl butyrate is used as the solvent. In butyl butyrate, the above-described specific binder can be dispersed well, and the reaction with the above-described sulfide solid electrolyte can be suppressed.

The solvent (butyl butyrate) used in the embodiment of the invention exhibits substantially no solubility in water. When the solvent is used in the positive electrode slurry, the water content in the solvent (butyl butyrate) is preferably 100 ppm or lower in terms of mass.

1.1.5. Other Optional Components

In the embodiment of the invention, the positive electrode slurry may further contain optional components other than the above-described components within a range where the effects of the invention do not deteriorate. Examples of the optional components include a conductive additive. As the conductive additive, a well-known material can be used. Examples of the conductive additive include carbon fiber.

In the step of preparing a positive electrode slurry, the above-described respective components are mixed with each other to prepare a positive electrode slurry. The mixing order of the respective components is not particularly limited, and it is only necessary to add the respective components to the solvent and to mix the respective components.

Examples of the configuration of a dispersion treatment of dispersing each component in the solvent include an ultrasonic treatment and a dispersion treatment using a high-speed disk.

In the step of preparing a positive electrode slurry, a mixing ratio of the binder, the positive electrode active material, and the sulfide solid electrolyte is not particularly limited as long as a positive electrode obtained from the slurry appropriately functions. For example, a well-known mixing ratio can be adopted. However, according to the finding of the present inventors, it is particularly preferable that the content of the binder is 0.5 parts by mass to 3.5 parts by mass with respect to 100 parts by mass of the positive electrode active material. When the content of the binder is excessively low, in a positive electrode obtained from the slurry, the adhesion in a positive electrode layer and the adhesion between the positive electrode layer and a current collector are poor, and it may be difficult to handle the positive electrode. On the other hand, when the content of the binder is excessively high, the resistance of a positive electrode increases, and it may be difficult to obtain a solid-state battery having sufficient performance.

In the step of preparing a positive electrode slurry, a ratio of the amount of the solid content (the positive electrode active material, the sulfide solid electrolyte, the binder, and other optional components) to the amount of the solvent is not particularly limited. For example, the ratio of the amount of the solid content in the positive electrode slurry is preferably 30 mass % to 75 mass %. When the solid content ratio is in the above-described range, a positive electrode can be more easily manufactured. The lower limit of the solid content ratio is more preferably 55 mass % or higher, and the upper limit thereof is more preferably 70 mass % or lower.

1.2. Application of Positive Electrode Slurry

In the embodiment of the invention, the positive electrode slurry prepared as described above is applied. For example, the positive electrode slurry is applied to a substrate. As the substrate, for example, not only a substrate such as a metal foil or a metal mesh which functions as a positive electrode current collector but also a substrate film from which a dry positive electrode layer can be easily peeled off after drying described below may be used. Alternatively, the positive electrode slurry may be applied to a surface of a solid electrolyte layer of a solid-state battery. From the viewpoint of obtaining superior adhesion between a positive electrode layer and a current collector after drying, it is preferable that the positive electrode slurry is applied to a surface of the current collector among the above-described substrates. As the current collector, any material which is well-known as a positive electrode current collector can be used. For example, aluminum foil can be preferably used.

The application of the positive electrode slurry can be performed using a well-known method. Examples of the method include a method using a spray and a method using a doctor blade. From the viewpoint of uniformly and easily applying the positive electrode slurry to the substrate surface, the method using a doctor blade is preferable.

1.3. Drying of Positive Electrode Slurry

In the embodiment of the invention, the positive electrode slurry applied as described above is dried. As a result, a positive electrode layer containing the positive electrode active material, the sulfide solid electrolyte, and the binder can be formed on the substrate surface, and a positive electrode for a solid-state battery can be obtained. Here, in the embodiment of the invention, butyl butyrate is used as the solvent, and the two-component binder having the predetermined copolymerization ratio is used as the binder. Therefore, the adhesion strength of the positive electrode layer is high. That is, the positive electrode layer can be strongly adhered to the substrate surface.

The drying method may be natural drying or heating drying (fast drying) using heating means. From the viewpoint of obtaining superior productivity, fast drying is preferable. The drying temperature and the drying time may be appropriately adjusted depending on, for example, the amount of the solvent contained in the positive electrode slurry and the configuration of the positive electrode layer obtained from the slurry. Here, in the embodiment of the invention, butyl butyrate is used as the solvent, and the two-component binder having the specific copolymerization ratio is used as the binder. Therefore, even when fast drying is performed, an increase in resistance and a decrease in battery output can be suppressed.

The configuration (for example, thickness) of the positive electrode layer formed after drying is not particularly limited as long as it is appropriate for a positive electrode of a sulfide solid-state battery. For example, the positive electrode layer may be a thin film having a thickness of 40 μm to 120 μm.

As described above, in the method of manufacturing a positive electrode for a solid-state battery according to the embodiment of the invention, the two-component binder of VDF and HFP having the predetermined copolymerization ratio is used as the binder, and butyl butyrate is used as the solvent. Therefore, deterioration of the sulfide solid electrolyte caused by the reaction with the solvent can be suppressed, a sufficient adhesive force can be secured between the current collector and the positive electrode layer, and a decrease in battery output caused by fast drying can be suppressed.

2. Method of Manufacturing Solid-State Battery

According to another aspect of the invention, a method of manufacturing a solid-state battery is provided. That is, the method of manufacturing a solid-state battery includes a step of laminating a positive electrode for a solid-state battery which is obtained using the above-described method of manufacturing a positive electrode for a solid-state battery, a solid electrolyte layer containing a solid electrolyte, and a negative electrode containing a negative electrode active material. In the solid-state battery, the positive electrode obtained using the above-described manufacturing method only needs to be used, and the configurations of the components other than the positive electrode are not particularly limited. However, a sulfide all-solid-state battery in which both the solid electrolyte layer and the negative electrode contain the above-described sulfide solid electrolyte is preferable, and a sulfide all-solid-state lithium battery is most preferable.

2.1. Solid Electrolyte Layer

When the solid-state battery is manufactured, it is necessary to form a solid electrolyte layer. The solid electrolyte layer can be easily obtained using a well-known method. For example, a solid electrolyte and a binder are added to a solvent to prepare an electrolyte slurry, and the electrolyte slurry is applied to a substrate and is dried. As a result, a solid electrolyte layer can be formed on the substrate. By removing the substrate from the laminate, the solid electrolyte layer is obtained. Alternatively, the electrolyte slurry may be applied to the surface of the positive electrode to directly form the solid electrolyte layer on the surface of the positive electrode, and the solid electrolyte layer may be directly formed on the surface of the negative electrode described below using the same method. Further, the solid electrolyte layer may be formed without using the electrolyte slurry. That is, the solid electrolyte layer may be obtained by mixing solid electrolyte powder and a binder with each other using a dry method and press-forming the mixture by, for example, hot pressing.

In the invention, the configuration of the solid electrolyte layer is not particularly limited. During the formation of the solid electrolyte layer, as the binder and the solvent used in the electrolyte slurry, a binder and a solvent other than the binder and butyl butyrate contained in the positive electrode slurry may also be used. For example, butadiene rubber may be used as the binder, and heptane may be used as the solvent. In addition, the solid electrolyte used in the solid electrolyte layer is not limited to the sulfide solid electrolyte. For example, the solid electrolyte layer may be formed using an oxide solid electrolyte. However, from the viewpoint of obtaining a solid-state battery having higher performance, it is preferable that the solid electrolyte layer is formed by using the sulfide solid electrolyte as the solid electrolyte.

2.2. Negative Electrode

When the solid-state battery is manufactured, it is necessary to manufacture a negative electrode. The negative electrode can be easily obtained using a well-known method. For example, a negative electrode active material, a solid electrolyte, and a binder are added to a solvent to prepare a negative electrode slurry, and the negative electrode slurry is applied to a substrate and is dried. As a result, a negative electrode layer can be formed on the substrate. In this case, as in the case of the formation of the positive electrode layer, various substrates such as a current collector can be used as the substrate. As the current collector, any material which is well-known as a negative electrode current collector can be used. For example, copper foil can be preferably used. Alternatively, the negative electrode slurry may be applied to the surface of the solid electrolyte layer to directly form the negative electrode layer on the surface of the solid electrolyte layer. Further, the negative electrode may be manufactured without using the negative electrode slurry. That is, the negative electrode layer may be obtained by mixing negative electrode active material powder, solid electrolyte powder, and a binder with each other using a dry method and press-forming the mixture on the current collector by, for example, hot pressing. Alternatively, after the negative electrode layer is obtained by hot pressing, the current collector may be attached to the surface of the negative electrode layer.

In the invention, the configuration of the negative electrode is not particularly limited. During the manufacture of the negative electrode, as the binder and the solvent used in the negative electrode slurry, a binder and a solvent other than the binder and butyl butyrate contained in the positive electrode slurry may also be used. In addition, as the negative electrode active material, a material which is well-known as a negative electrode active material for a solid-state battery may be used. In particular, a negative electrode active material capable of storing and releasing lithium ions is preferably used. Examples of the negative electrode active material include a lithium alloy, a metal oxide, a carbon material such as graphite or hard carbon, silicon, a silicon alloy, and Li₄Ti₅O₁₂. In particular, graphite is preferable. The solid electrolyte contained in the negative electrode is not particularly limited, and an oxide solid electrolyte may also be used in addition to the sulfide solid electrolyte. However, from the viewpoint of obtaining a solid-state battery having higher performance, it is preferable that the negative electrode is manufactured by using the sulfide solid electrolyte as the solid electrolyte.

The negative electrode, the solid electrolyte layer, and the positive electrode which are obtained as described above are punched into predetermined sizes and are laminated to obtain a laminate. This laminate is press-formed under an appropriate pressure to be integrated. As a result, a power generation unit including the positive electrode, the solid electrolyte layer, and the negative electrode in this order can be manufactured. Appropriate terminals and the like are provided in the power generation unit. Next, for example, the power generation unit is accommodated in a battery case. As a result, a solid-state battery can be easily manufactured. Here, in the embodiment of the invention, a high adhesive force can be secured between the positive electrode layer and the current collector in the positive electrode. Therefore, during the punching of the positive electrode, the cracking or peeling of the positive electrode can be suppressed. In addition, in the embodiment of the invention, the positive electrode is manufactured using the above-described method. Therefore, an increase in battery resistance can be suppressed, and a high-output battery can be obtained.

3. Positive Electrode Slurry

According to still another aspect of the invention, a positive electrode slurry for a solid-state battery is provided. That is, the positive electrode slurry contains a positive electrode active material, a sulfide solid electrolyte, a binder, and a solvent. In the positive electrode slurry, the solvent is butyl butyrate, and the binder is a copolymer consisting of a vinylidene fluoride (VDF) monomer unit and a hexafluoropropylene (HFP) monomer unit, in which a molar ratio of the HFP monomer unit to a total amount of the VDF monomer unit and the HFP monomer unit is 10% to 20%. Since the details of the respective components are as described above, the description thereof will not be repeated.

As described above, in the positive electrode slurry according to the embodiment of the invention, the two-component binder of VDF and HFP having the predetermined copolymerization ratio is used as the binder, and butyl butyrate is used as the solvent. Therefore, deterioration of the sulfide solid electrolyte caused by the reaction with the solvent can be suppressed, a sufficient adhesive force can be secured between the current collector and the positive electrode layer in the positive electrode obtained from the slurry, and a decrease in battery output caused by fast drying can be suppressed.

Hereinafter, the invention will be described in more detail using Examples but is not limited to the following specific configurations.

1. Problem of Binder of Related Art

A positive electrode slurry was prepared by using a three-component copolymer consisting of a VDF monomer unit, a TFE monomer unit, and a HFP monomer unit as a binder. The slurry was applied and dried by fast drying to manufacture a positive electrode. When a battery is manufactured using the positive electrode, the battery output may decrease further than in a case where a positive electrode is manufactured by natural drying. As a result of thorough research, it was found that the battery output decreased because the binder was segregated on the surface of the positive electrode during fast drying to increase the resistance. When a combination of a binder and a solvent of the related art was used, there was a problem in that the adhesion between a positive electrode layer and a current collector was not sufficient and a problem in that a sulfide solid electrolyte deteriorated with a reaction with a solvent. In order to solve these problems, the binder and the solvent used in the positive electrode slurry were investigated.

2. Preparation of Positive Electrode

2.1. Preparation of Binder Solution

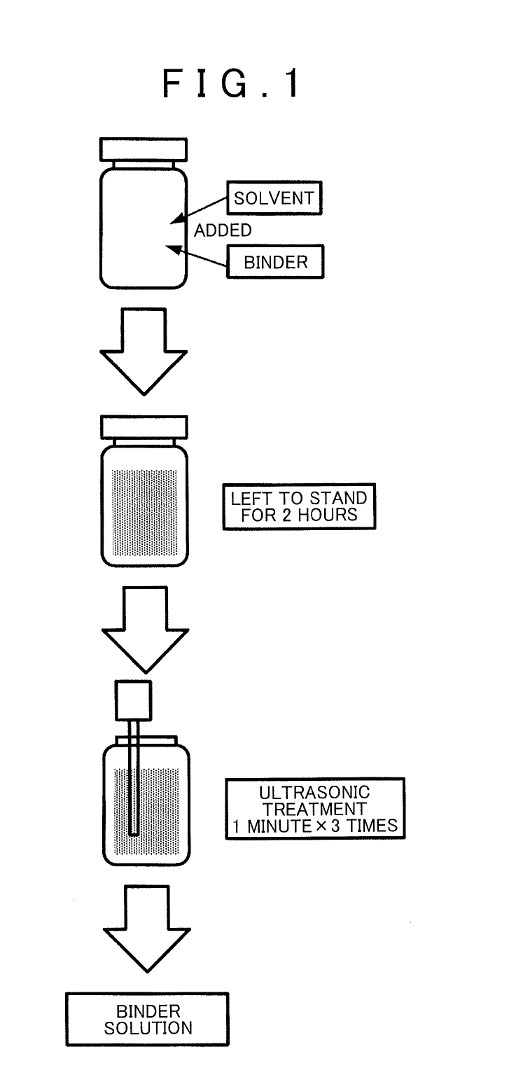

A binder solution was prepared in the procedure shown in FIG. 1. The details are as follows.

### Preparation Example 1

Powder of polyvinylidene fluoride (PVDF, VDF 100%) was added to butyl methacrylate (manufactured by Kishida Chemical Co., Ltd.), and the components were stirred overnight. As a result, a binder solution (1) was prepared. Here, the content of the binder was 20 mass % with respect to 100 mass % of the total amount of the binder solution (1). PVDF was not able to be dissolved or dispersed in butyl butyrate. Therefore, as a solvent for the binder solution, butyl methacrylate was used instead of butyl butyrate.

### Preparation Example 2

Three-component binder powder obtained by copolymerizing VDF, TFE, and HFP at a ratio of 55 mol %:25 mol %:20 mol % was prepared. This binder powder was added to butyl butyrate (manufactured by Kishida Chemical Co., Ltd.), and the components were stirred overnight such that the binder was dissolved in the solvent. As a result, a binder solution (2) was prepared. Here, the content of the binder was 5 mass % with respect to 100 mass % of the total amount of the binder solution (2).

### Preparation Example 3

Two-component binder powder obtained by copolymerizing HFP and VDF at a ratio of 10 mol %:90 mol % was prepared. This binder powder was added to butyl butyrate (manufactured by Kishida Chemical Co., Ltd.), the binder was left to stand in butyl butyrate for two hours such that the binder was swollen, and then an ultrasonic treatment (1 minute) was performed thereon three times using an ultrasonic homogenizer (UD50 (50 W) manufactured by SMT Corporation). As a result, a binder solution (3) was prepared. Here, the content of the binder was 5 mass % with respect to 100 mass % of the total amount of the binder solution (3). The binder was not completely dissolved in butyl butyrate and was highly dispersed therein.

### Preparation Example 4

Two-component binder powder obtained by copolymerizing HFP and VDF at a ratio of 15 mol %:85 mol % was prepared. This binder powder was added to butyl butyrate (manufactured by Kishida Chemical Co., Ltd.), the binder was left to stand in butyl butyrate for two hours such that the binder was swollen, and then an ultrasonic treatment (1 minute) was performed thereon three times using an ultrasonic homogenizer (UD50 (50 W) manufactured by SMT Corporation). As a result, a binder solution (4) was prepared. Here, the content of the binder was 5 mass % with respect to 100 mass % of the total amount of the binder solution (4). The binder was not completely dissolved in butyl butyrate and was highly dispersed therein.

### Preparation Example 5

Two-component binder powder obtained by copolymerizing HFP and VDF at a ratio of 20 mol %:80 mol % was prepared. This binder powder was added to butyl butyrate (manufactured by Kishida Chemical Co., Ltd.), the binder was left to stand in butyl butyrate for two hours such that the binder was swollen, and then an ultrasonic treatment (1 minute) was performed thereon three times using an ultrasonic homogenizer (UD50 (50 W) manufactured by SMT Corporation). As a result, a binder solution (5) was prepared. Here, the content of the binder was 5 mass % with respect to 100 mass % of the total amount of the binder solution (5). The binder was not completely dissolved in butyl butyrate and was highly dispersed therein.

2.2. Preparation of Positive Electrode Slurry

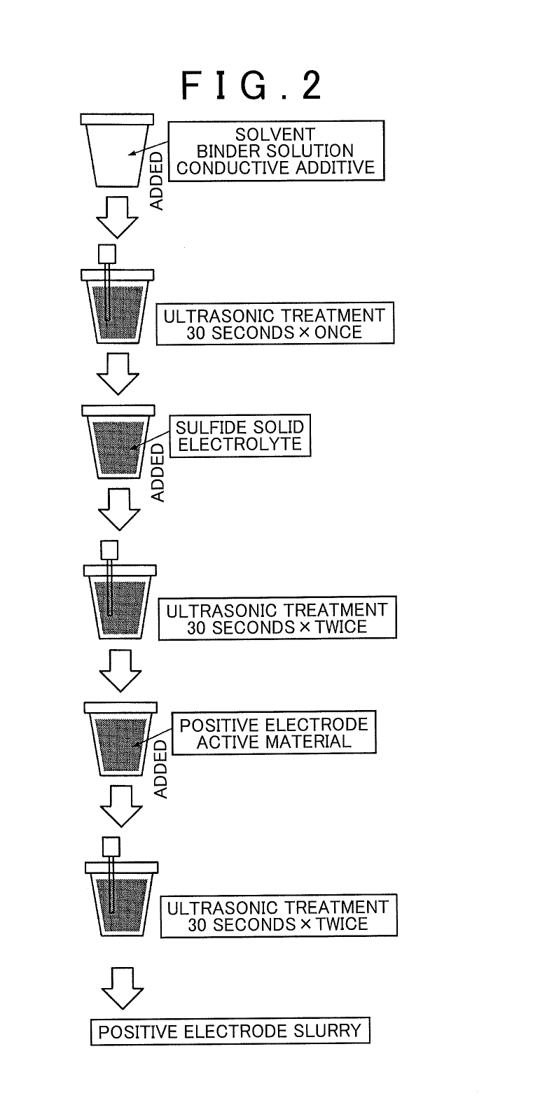

Using a solvent, the prepared binder solutions, a conductive additive, a sulfide solid electrolyte, and a positive electrode active material, positive electrode slurries according to Examples and Comparative Examples were prepared in the procedure shown in FIG. 2. The details are as follows.

### Comparative Example 1

In a 9 ml PET container, the binder solution (1) according to Preparation Example 1 and carbon fiber (VGCF, manufactured by Showa Denko K.K.) as a conductive additive were added to butyl butyrate as a solvent, and an ultrasonic treatment (30 seconds) was performed thereon once using an ultrasonic homogenizer (UD50 (50 W) manufactured by SMT Corporation). A sulfide solid electrolyte (30LiI.70(0.75Li₂S.0.25P₂S₅)) was added to the obtained slurry, and the ultrasonic treatment (30 seconds) was performed thereon twice. Next, a positive electrode active material (a three-element positive electrode active material (LiNi_{1/3}Mn_{1/3}CO_{1/3}O₂, manufactured by Nichia Corporation) with a surface on which a lithium niobate coating layer having a thickness of about 10 μm was formed) was further added to the slurry, and the ultrasonic treatment (30 seconds) was performed thereon twice. As a result, a positive electrode slurry according to Comparative Example 1 was obtained. A mass ratio (positive electrode active material:binder) of the positive electrode active material to the binder was 100:2.5. A solid content ratio in the positive electrode slurry was 60 mass % (in the following Examples and Comparative Examples, the mass ratios and the solid content ratios were the same). In Comparative Example 1, butyl methacrylate was used as the solvent in the binder solution (1). As a result, the solvent in the positive electrode slurry was a mixed solvent of butyl methacrylate and butyl butyrate. In Comparative Example 1, the content of butyl methacrylate was 20 mass % with respect to the total amount of the solvent.

### Comparative Example 2

A positive electrode slurry was obtained in the same procedure as that of Comparative Example 1, except that N-methylpyrrolidone (NMP) was used as the solvent instead of butyl butyrate (nBB).

### Comparative Example 3

A positive electrode slurry was obtained in the same procedure as that of Comparative Example 1, except that dibutyl ether (DBE) was used as the solvent instead of butyl butyrate (nBB).

### Comparative Example 4

A positive electrode slurry was obtained in the same procedure as that of Comparative Example 1, except that cyclopentyl methyl ether (CPME) was used as the solvent instead of butyl butyrate (nBB).

### Comparative Example 5

A positive electrode slurry was obtained in the same procedure as that of Comparative Example 1, except that the binder solution (2) was used instead of the binder solution (1).

### Comparative Example 6

A positive electrode slurry was obtained in the same procedure as that of Comparative Example 5, except that N-methylpyrrolidone (NMP) was used as the solvent instead of butyl butyrate (nBB).

### Comparative Example 7

A positive electrode slurry was obtained in the same procedure as that of Comparative Example 5, except that dibutyl ether (DBE) was used as the solvent instead of butyl butyrate (nBB).

### Comparative Example 8

A positive electrode slurry was obtained in the same procedure as that of Comparative Example 5, except that cyclopentyl methyl ether (CPME) was used as the solvent instead of butyl butyrate (nBB).

### Comparative Example 9

A positive electrode slurry was obtained in the same procedure as that of Comparative Example 1, except that the binder solution (3) was used instead of the binder solution (1), and N-methylpyrrolidone (NMP) was used as the solvent instead of butyl butyrate (nBB).

### Comparative Example 10

A positive electrode slurry was obtained in the same procedure as that of Comparative Example 9, except that dibutyl ether (DBE) was used as the solvent instead of N-methylpyrrolidone (NMP).

### Comparative Example 11

A positive electrode slurry was obtained in the same procedure as that of Comparative Example 9, except that cyclopentyl methyl ether (CPME) was used as the solvent instead of N-methylpyrrolidone (NMP).

### Comparative Example 12

A positive electrode slurry was obtained in the same procedure as that of Comparative Example 1, except that the binder solution (5) was used instead of the binder solution (1), and N-methylpyrrolidone (NMP) was used as the solvent instead of butyl butyrate (nBB).

### Comparative Example 13

A positive electrode slurry was obtained in the same procedure as that of Comparative Example 12, except that dibutyl ether (DBE) was used as the solvent instead of N-methylpyrrolidone (NMP).

### Comparative Example 14

A positive electrode slurry was obtained in the same procedure as that of Comparative Example 12, except that cyclopentyl methyl ether (CPME) was used as the solvent instead of N-methylpyrrolidone (NMP).

### Example 1

A positive electrode slurry was obtained in the same procedure as that of Comparative Example 1, except that the binder solution (3) was used instead of the binder solution (1).

### Example 2

A positive electrode slurry was obtained in the same procedure as that of Comparative Example 1, except that the binder solution (4) was used instead of the binder solution (1).

### Example 3

A positive electrode slurry was obtained in the same procedure as that of Comparative Example 1, except that the binder solution (5) was used instead of the binder solution (1).

2.3. Application and Drying of Positive Electrode Slurry

Each of the positive electrode slurries was applied to aluminum foil as a positive electrode current collector using a doctor blade and was dried by natural drying or fast drying. As a result, a positive electrode layer having a thickness of 40 μm to 120 μm was formed on a surface of the positive electrode current collector, and a positive electrode was obtained.

Conditions of natural drying were as follows. After the application, the slurry was left to stand at room temperature for 60 minutes and then was heated on a hot plate at 100° C. for 30 minutes to remove the remaining solvent. By simply drying the slurry at room temperature for 60 minutes, substantially the total amount of the remaining solvent was dried to be 1% or less. However, in Examples, after natural drying, the slurry was dried at 100° C. in order to examine the effect of the remaining solvent on the performance.

Conditions of fast drying using heating were as follows. After the application, the slurry was placed on a hot plate and was heated at 150° C. for 1 minute to remove the solvent.

3. Manufacture of Negative Electrode

A negative electrode slurry was prepared by using butyl butyrate (manufactured by Kishida Chemical Co., Ltd.) as a solvent, using graphite (manufactured by Mitsubishi Chemical Corporation) as a negative electrode active material (1), using aluminum powder (manufactured by Kojundo Chemical Laboratory Co., Ltd.) as a negative electrode active material (2), using the sulfide solid electrolyte as a solid electrolyte, and using the three-component binder solution (2) as the binder solution. Specifically, in a 9 ml PET container, the binder solution (2) according to Preparation Example 2 and the negative electrode active materials (1) and (2) were added to butyl butyrate (manufactured by Kishida Chemical Co., Ltd.) as the solvent, and an ultrasonic treatment (30 seconds) was performed thereon once using an ultrasonic homogenizer (UD50 (50 W) manufactured by SMT Corporation). As a result, “a negative electrode active material-binder slurry” was prepared. The binder solution (2) according to Preparation Example 2 and a sulfide solid electrolyte (30LiI.70(0.75Li₂S.0.25P₂S₅)) were added to the obtained negative electrode active material-binder slurry, and an ultrasonic treatment (30 seconds) was performed thereon three times using an ultrasonic homogenizer (UD50 (50 W) manufactured by SMT Corporation). As a result, “a negative electrode slurry” in which the negative electrode active materials, the sulfide solid electrolyte, and the binder were highly dispersed was obtained. In the negative electrode slurry, a mass ratio (active material (1):active material (2):binder) of the active materials and the binder was 100:4.2:3.5. A solid content ratio in the negative electrode slurry was 63 mass %.

The prepared negative electrode slurry was applied to copper foil as a negative electrode current collector using a doctor blade and was dried. As a result, a negative electrode layer having a thickness of 90 μm was formed on a surface of the negative electrode current collector, and a negative electrode was obtained.

4. Preparation of Solid Electrolyte Layer

An electrolyte slurry was prepared by using heptane as a solvent, using the sulfide solid electrolyte as a solid electrolyte, and using a heptane solution of butadiene rubber as a binder solution. Specifically, the solid electrolyte and the binder solution were added to heptane as the solvent, and an ultrasonic treatment (30 seconds) was performed thereon four times using an ultrasonic homogenizer (UD50 (50 W) manufactured by SMT Corporation). As a result, the electrolyte slurry in which the solid electrolyte and the binder were highly dissolved or dispersed was obtained. In the electrolyte slurry, a mass ratio (solid electrolyte:binder) of the solid electrolyte to the binder was 100 parts by mass:1 part by mass. A solid content ratio in the electrolyte slurry was 40 mass %.

The prepared electrolyte slurry was applied to a peelable substrate (aluminum foil) using a doctor blade and was dried. As a result, a solid electrolyte layer having a thickness of 30 μm to 60 μm was formed on the substrate.

5) Preparation of Solid-State Battery

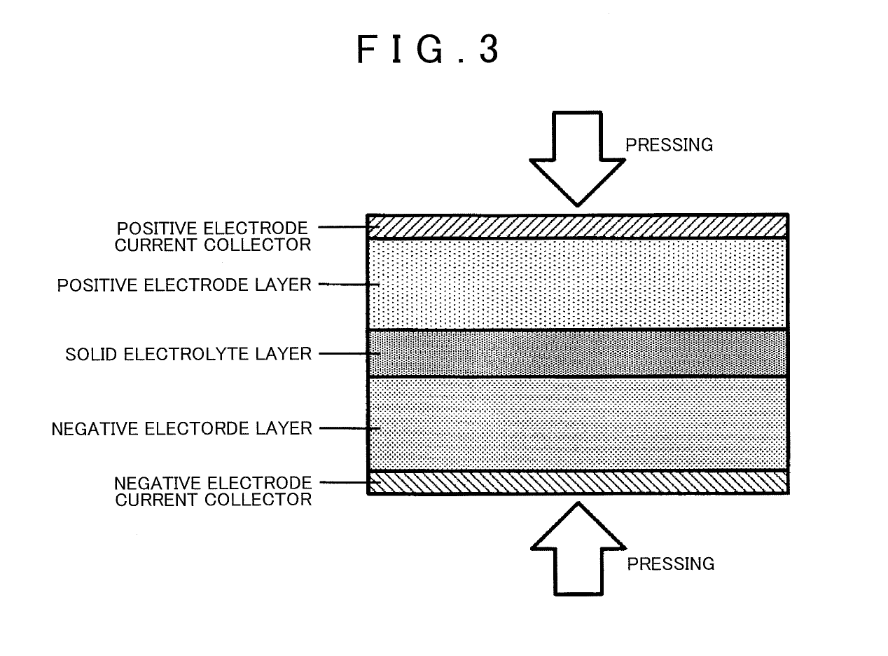

The positive electrode, the negative electrode, and the solid electrolyte layer prepared as described above were punched. Next, as shown in FIG. 3, the positive electrode and the negative electrode were laminated to face each other with the solid electrolyte layer, from which the substrate was removed, interposed therebetween. The obtained laminate was pressed to be integrated. As a result, a solid-state battery was prepared.

6. Performance Evaluation

### (1) Evaluation of Reactivity Between Solvent and Electrolyte

The sulfide solid electrolyte was in contact with the solvent for a predetermined amount of time. A lithium ion conductivity in the sulfide solid electrolyte before the contact with the solvent and a lithium ion conductivity in the sulfide solid electrolyte after the contact with the solvent were measured, and the reactivity between the solvent and the electrolyte was evaluated. The evaluation criteria were as follows.

◯: The Li ion conductivity after the content was maintained to be 90% or higher as compared to that before the contact
X: Due to the reaction between the solvent and the electrolyte, the electrode was not able to be formed, and the Li ion conductivity was not able to be measured

### (2) Evaluation of Adhesive Force

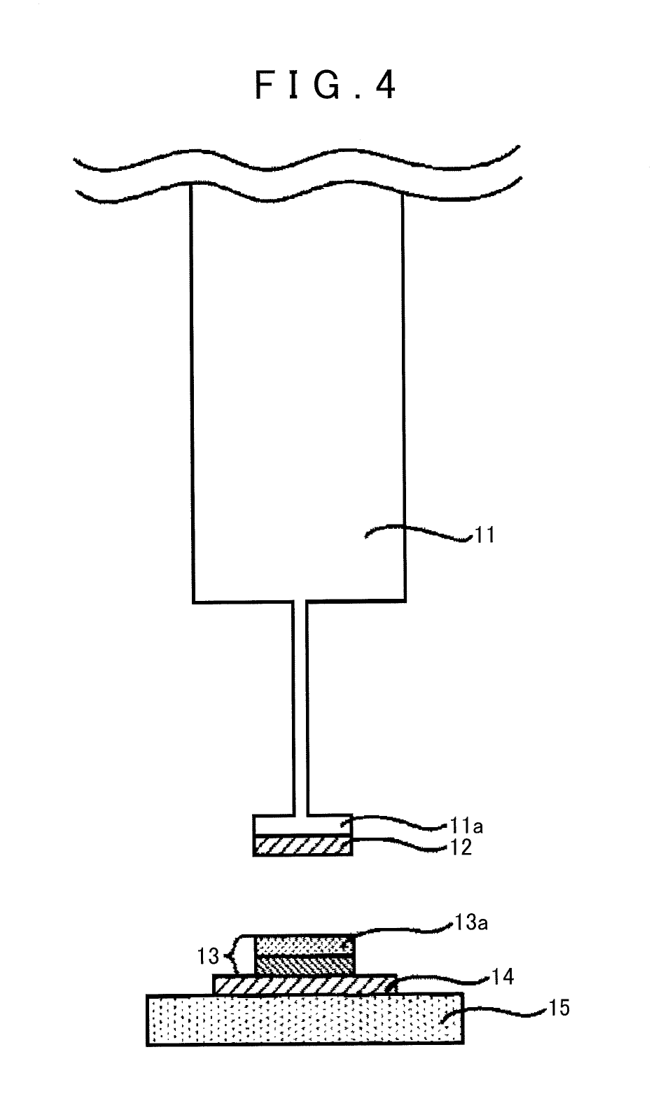

The adhesive force between the positive electrode current collector and the positive electrode layer was evaluated. Specifically, using a tensile load measuring device (RX-5/MODEL-2257, manufactured by AIKOH Engineering Co., Ltd.), a vertical peel test was performed in a glove box in an argon atmosphere at room temperature. FIG. 4 is a schematic sectional diagram showing the summary of the configuration of measuring the adhesive force. In FIG. 4, a double wavy line represents omission in the drawing. First, a sample 13 was fixed to a stand 15 through a double-sided adhesive tape 14 such that a surface 13a (positive electrode layer) to which the positive electrode slurry was applied faced upward. Another double-sided adhesive tape 12 was attached to an attachment tip end portion 11a of the tensile load measuring device 11, and an adhesive surface of the double-sided adhesive tape was positioned to face the sample 13 side. The tensile load measuring device 11 was lowered at a constant speed (about 20 mm/min) vertically to the sample 13 such that the double-sided adhesive tape 12 came into contact with the surface 13a (positive electrode layer) to which the positive electrode slurry was applied. Next, the tensile load measuring device 11 was raised. When the coating film (positive electrode layer) was peeled off, the tensile load was obtained as the adhesive force of the sample. The adhesive force was evaluated as the following evaluation criteria.

◯: more than 10 N/cm²

### Δ: 2 N/cm² to 10 N/cm²

X: less than 2 N/cm²

### (3) Evaluation of Battery Output

The resistance values (Ω) of solid-state batteries in which the positive electrode was dried by natural drying were compared to the resistance values of solid-state batteries in which the positive electrode was dried by fast drying.

The evaluation results of the reactivity of the electrolyte and the evaluation results of the adhesive force are shown in Table 1 below.

TABLE 1

| | | | Binder | Reactivity | |
|---|---|---|---|---|---|
| | | | Composition | with | Adhesive |
| | Solvent | Kind of Binder | (mol %) | Electrolyte | Force |
| Comparative | nBB | PVDF | VDF 100 | ◯ | X |
| Example 1 | | | | | |
| Comparative | NMP | PVDF | VDF 100 | X | Not Able to |
| Example 2 | | | | | Manufacture |
| | | | | | Positive |
| | | | | | Electrode |
| Comparative | DBE | PVDF | VDF 100 | ◯ | X |
| Example 3 | | | | | |
| Comparative | CPME | PVDF | VDF 100 | ◯ | X |
| Example 4 | | | | | |
| Comparative | nBB | VDF/TFE/HFP | VDF:TFE:HFP = | ◯ | Δ |
| Example 5 | | | 55:25:20 | | |
| Comparative | NMP | VDF/TFE/HFP | VDF:TFE:HFP = | X | Not Able to |
| Example 6 | | | 55:25:20 | | Manufacture |
| | | | | | Positive |
| | | | | | Electrode |
| Comparative | DBE | VDF/TFE/HFP | VDF:TFE:HFP = | ◯ | X |
| Example 7 | | | 55:25:20 | | |
| Comparative | CPME | VDF/TFE/HFP | VDF:TFE:HFP = | ◯ | X |
| Example 8 | | | 55:25:20 | | |
| Comparative | NMP | VDF/HFP | VDF:HFP = | X | Not Able to |
| Example 9 | | | 90:10 | | Manufacture |
| | | | | | Positive |
| | | | | | Electrode |
| Comparative | DBE | VDF/HFP | VDF:HFP = | ◯ | X |
| Example 10 | | | 90:10 | | |
| Comparative | CPME | VDF/HFP | VDF:HFP = | ◯ | X |
| Example 11 | | | 90:10 | | |
| Comparative | NMP | VDF/HFP | VDF:HFP = | X | Not Able to |
| Example 12 | | | 80:20 | | Manufacture |
| | | | | | Positive |
| | | | | | Electrode |
| Comparative | DBE | VDF/HFP | VDF:HFP = | ◯ | X |
| Example 13 | | | 80:20 | | |
| Comparative | CPME | VDF/HFP | VDF:HFP = | ◯ | X |
| Example 14 | | | 80:20 | | |
| Example 1 | nBB | VDF/HFP | VDF:HFP = | ◯ | ◯ |
| | | | 90:10 | | |
| Example 2 | nBB | VDF/HFP | VDF:HFP = | ◯ | ◯ |
| | | | 85:15 | | |
| Example 3 | nBB | VDF/HFP | VDF:HFP = | ◯ | ◯ |
| | | | 80:20 | | |

<Evaluation Results of Reactivity Between Solvent and Electrolyte>

As shown in Table 1, when nBB, DBE, or CPME was used as the solvent, the reaction between the solvent and the sulfide solid electrolyte was able to be suppressed. On the other hand, when NMP was used as the solvent (Comparative Examples 2, 6, 9, and 12), the solvent and the sulfide solid electrolyte reacted with each other, and it was difficult to manufacture the positive electrode. Specifically, after being dissolved in the solvent, the sulfide solid electrolyte was maintained in sticky state and was not able to be dried. Of course, the solid-state battery was not able to be manufactured.

<Evaluation Results of Adhesive Force>

### (When nBB was Used as the Solvent)

As shown in Table 1, when nBB was used as the solvent, the adhesion largely varied depending on the kind of the binder. Specifically, when PVDF was used as the binder (Comparative Example 1), the adhesive force between the positive electrode layer and the current collector was lower than 2 N/cm². When the positive electrode was punched during the manufacture of the solid-state battery, the peeling or cracking of the positive electrode was observed, and the yield may decrease during the manufacture of the solid-state battery. In addition, when the three-component binder consisting of VDF, TFE, and HFP was used as the binder (Comparative Example 5), the adhesive force was 2 N/cm² or higher. However, when the positive electrode was punched during the manufacture of the solid-state battery, the peeling or cracking of the positive electrode was observed at predetermined intervals, and a sufficient adhesive force was not able to be obtained. On the other hand, when the two-component binder, which was obtained by copolymerizing VDF and HFP at a predetermined ratio, was used as the binder (Examples 1 to 3), the adhesive force was significantly improved. In addition, when the negative electrode was punched during the manufacture of the solid-state battery, substantially no peeling or cracking of the negative electrode occurred.

(When NMP was Used as the Solvent)

As described above, when NMP was used as the solvent (Comparative Examples 2, 6, 9, and 12), the problem of the sticky state of the sulfide solid electrolyte was not able to be solved, and the positive electrode was not able to be manufactured.

(When DBE was Used as the Solvent)

As shown in Table 1, when DBE was used as the solvent, a sufficient adhesive force was not able to be obtained irrespective of the kind of the binder. Specifically, when PVDF was used as the binder (Comparative Example 3), when the three-component binder of VDF, TFE, and HFP was used as the binder (Comparative Example 7), or when the two-component binder consisting of VDF and HFP was used as the binder (Comparative Examples 10 and 13), the positive electrode was able to be manufactured, but the adhesive force was so low that the positive electrode was not able to be punched.

(When CPME was Used as the Solvent)

As shown in Table 1, when CPME was used as the solvent, a sufficient adhesive force was not able to be obtained irrespective of the kind of the binder. As compared to a case where DBE was used as the solvent, the adhesive force was slightly improved, and the positive electrode was able to be punched only in a small number of the examples.

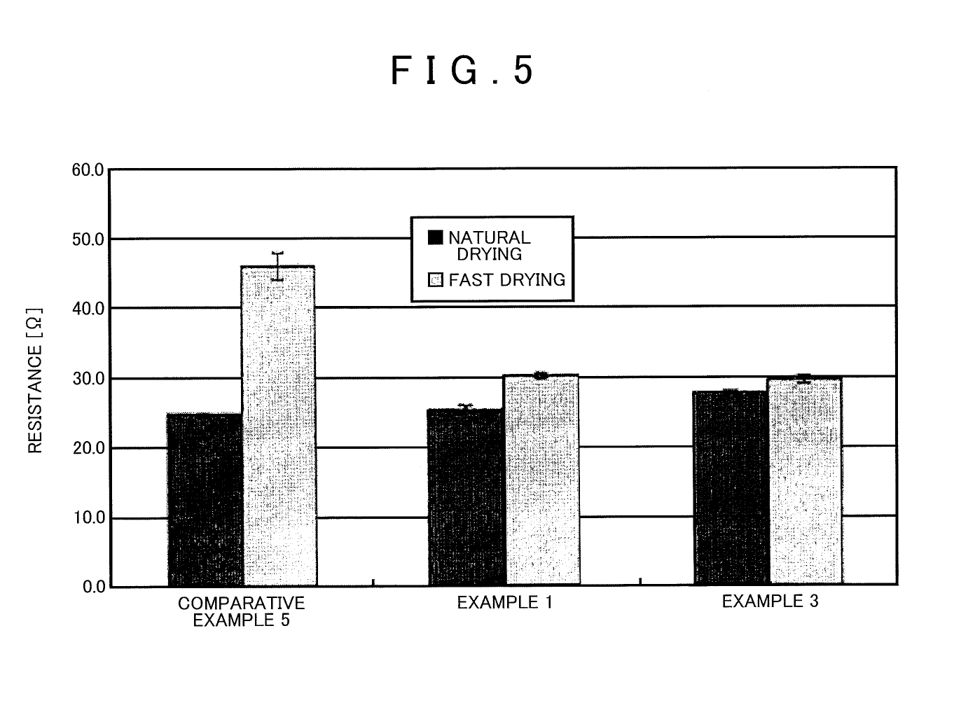

The evaluation results of the battery output are shown in FIG. 5. In FIG. 5, in Comparative Example 5 and Examples 1 and 3, the resistance values of solid-state batteries in which the positive electrode was dried by natural drying were compared to the resistance values of solid-state batteries in which the positive electrode was dried by fast drying. As clearly seen from the results shown in FIG. 5, in Comparative Example 5, when the positive electrode was manufactured by fast drying, the resistance of the solid-state battery was increased to be about two times that of the case where the positive electrode was manufactured by natural drying, and the output of the solid-state battery was decreased. On the other hand, in Examples 1 and 3, when the positive electrode was manufactured by fast drying, the battery resistance was substantially the same as that of the case where the positive electrode was manufactured by natural drying.

The following facts were found from the above results. During the manufacture of a positive electrode for a solid-state battery, in the positive electrode slurry, only when a two-component binder of VDF and HFP having a copolymerization ratio (molar ratio) of HFP of 10% to 20% is used as a binder, and when butyl butyrate is used as a solvent, deterioration of a sulfide solid electrolyte can be suppressed, a sufficient adhesive force can be secured between a current collector and a positive electrode layer, and a decrease in battery output caused by fast drying can be suppressed.

The positive electrode for a solid-state battery obtained according to the invention can be preferably used as a positive electrode for a sulfide solid-state battery. In particular, the positive electrode for a solid-state battery obtained according to the embodiment of the invention is useful as a positive electrode for an all-solid-state lithium secondary battery.

What is claimed is:

1. A method of manufacturing a positive electrode for a solid-state battery, the method comprising:
mixing a positive electrode active material, a sulfide solid electrolyte, a copolymer as a binder, and butyl butyrate as a solvent with each other to prepare a positive electrode slurry, in which the copolymer consists of a vinylidene fluoride monomer unit and a hexafluoropropylene monomer unit, and a molar ratio of the hexafluoropropylene monomer unit to a total amount of the vinylidene fluoride monomer unit and the hexafluoropropylene monomer unit is 10% to 20%;
applying the prepared positive electrode slurry to a surface of a solid electrolyte layer of the solid-state battery or a substrate of the positive electrode; and
drying the applied positive electrode slurry.

2. A method of manufacturing a solid-state battery, the method comprising:
laminating a positive electrode for a solid-state battery which is obtained using the method according to claim 1, a solid electrolyte layer containing a solid electrolyte, and a negative electrode containing a negative electrode active material.

3. A positive electrode slurry comprising:
a positive electrode active material;
a sulfide solid electrolyte;
a binder; and
a solvent,
wherein the solvent is butyl butyrate, and
the binder is a copolymer consisting of a vinylidene fluoride monomer unit and a hexafluoropropylene monomer unit, in which a molar ratio of the hexafluoropropylene monomer unit to a total amount of the vinylidene fluoride monomer unit and the hexafluoropropylene monomer unit is 10% to 20%.

4. The positive electrode slurry according to claim 3, wherein
a content of the binder is 0.5 parts by mass to 3.5 parts by mass with respect to 100 parts by mass of the positive electrode active material.
